(19) United States
(12) Patent Application Publication
(10) Pub. No.: US 2024/0261904 A1
(43) Pub. Date: Aug. 8, 2024

(54) GLASS PANEL PROCESSING METHOD

(71) Applicants: JOONGWOO NARA CO.,LTD., Ansan-si (KR); BSP CO., LTD., Anyang-si (KR)

(72) Inventors: Sung Soo PARK, Yongin-si (KR); Hong Jin PARK, Anyang-si (KR)

(73) Assignees: JOONGWOO NARA CO.,LTD., Ansan-si (KR); BSP CO., LTD., Anyang-si (KR)

(21) Appl. No.: 18/122,157

(22) Filed: Mar. 16, 2023

(30) Foreign Application Priority Data
Feb. 2, 2023 (KR) 10-2023-0014480

(51) Int. Cl. B23K 26/53; B23K 26/362; B23K 26/40; C03C 15/02

(52) U.S. Cl. CPC B23K 26/53; B23K 26/362; B23K 26/40; C03C 15/02; B23K 2103/54

(57) ABSTRACT

A method of processing a glass panel including a glass substrate and a display layer disposed on one surface of the glass substrate to display an image, includes: a deformed portion formation step in which, in order to process the glass substrate, a deformed portion is formed inside the glass substrate through irradiation with a Bessel beam along a planned processing line on the glass substrate; and an etching step in which the deformed portion is removed by etching the glass substrate in a direction from the other surface of the glass substrate to the one surface of the glass substrate, wherein, in the deformed portion formation step, irradiation with the Bessel beam is performed with half or more of the overall length of the Bessel beam positioned on the side of the glass substrate with respect to an interface between the glass substrate and the display layer.

### FIELD

The present invention relates to a glass panel processing method and, more particularly, to a glass panel processing method which can achieve cutting of a glass panel without adversely affecting the quality of the glass panel.

### BACKGROUND

Recently, a panel for display devices, such as smartphones and tablet computers, is manufactured in the form of a glass panel.

In general, a glass panel is manufactured by laminating a display layer and the like on a base substrate formed of glass.

Such a glass panel is manufactured in the form of a mother substrate and then divided into multiple unit glass panels by a cutting process. In most cases, such a cutting process is performed using a laser beam.

A display layer laminated on a glass substrate to display an image includes several metals. For example, for an OLED glass panel, the display layer may be composed of various layers, such as a circuit layer, an organic light emitting layer, and an encapsulation layer, and a metal interconnect.

During the glass panel cutting process using a laser beam, the laser beam can also fall on the display layer. The laser beam falling on the display layer can be reflected by the display layer. If the reflected laser beam is accidentally focused on a certain point in the glass substrate, a portion of the glass substrate with the laser beam focused thereon can be damaged.

This can cause deterioration of the quality of the glass panel and, even worse, can make the glass panel unusable.

Therefore, there is a need for a technology that can achieve cutting of a glass panel while preventing adverse effects of reflection of a laser beam from a display layer on the quality of the glass panel.

### SUMMARY

Embodiments of the present invention are conceived to solve such problems in the art and it is an object of the present invention to provide a glass panel processing method which can achieve cutting of a glass panel without adversely affecting the quality of the glass panel.

It will be understood that objects of the present invention are not limited to the above. The above and other objects of the present invention will become apparent to those skilled in the art from the detailed description of the following embodiments in conjunction with the accompanying drawings.

In accordance with one aspect of the present invention, there is provided a method of processing a glass panel including a glass substrate and a display layer disposed on one surface of the glass substrate to display an image, the method including: a deformed portion formation step in which, in order to process the glass substrate, a deformed portion is formed inside the glass substrate through irradiation with a Bessel beam along a planned processing line on the glass substrate; and an etching step in which the deformed portion is removed by etching the glass substrate in a direction from the other surface of the glass substrate to the one surface of the glass substrate, wherein, in the deformed portion formation step, irradiation with the Bessel beam is performed with half or more of the overall length of the Bessel beam positioned at the glass substrate side with respect to an interface between the glass substrate and the display layer.

In one embodiment, the display layer may have a greater reflectance than the glass substrate.

In one embodiment, in the deformed portion formation step, irradiation with the Bessel beam may be performed such that the deformed portion is formed to a length smaller than a thickness of the glass substrate.

According to the embodiments of the present invention, in a process in which a mother glass panel having a glass substrate and a display layer disposed on one surface of the glass substrate to display an image is cut into multiple unit glass panels using a Bessel beam, a deformed portion having an exact desired length can be formed inside the glass substrate even when the Bessel beam is reflected from the display layer.

It will be understood that advantageous effects of the present invention are not limited to the above effects, and the above and other advantageous effects of the present invention will become apparent to those skilled in the art from the detailed description of the following embodiments in conjunction with the accompanying drawings.

### DRAWINGS

The above and other aspects, features, and advantages of the present invention will become apparent from the detailed description of the following embodiments in conjunction with the accompanying drawings:

FIG. 1 is a flowchart of a glass panel processing method according to one embodiment of the present invention;

FIG. 2 is a schematic plan view illustrating the glass panel processing method according to the embodiment:

FIG. 3 is a schematic sectional view illustrating the glass panel processing method according to the embodiment:

FIG. 4 is a schematic view illustrating a Bessel beam used in the glass panel processing method according to one embodiment of the present invention:

FIG. 5 is a schematic sectional view illustrating an example of formation of a deformed portion depending on conditions of irradiation with the Bessel beam in the glass panel processing method according to one embodiment of the present invention:

FIG. 6 is a schematic view illustrating an example of irradiation with the Bessel beam in the glass panel processing method according to one embodiment of the present invention; and

FIG. 7 is a schematic view illustrating a comparative example of irradiation with the Bessel beam for comparison with the example of FIG. 6.

### DETAILED DESCRIPTION

Hereinafter, exemplary embodiments of the present invention will be described in detail with reference to the accompanying drawings. It should be understood that the present invention may be embodied in different ways and is not limited to the following embodiments. In the drawings, portions irrelevant to the description will be omitted for clarity. Like components will be denoted by like reference numerals throughout the specification.

Throughout the specification, when an element or layer is referred to as being “on”, “connected to”, or “coupled to” another element or layer, it may be directly on, connected to, or coupled to the other element or layer or intervening elements or layers may be present. In addition, unless stated otherwise, the term “includes” should be interpreted as not excluding the presence of other components than those listed herein.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises”, “comprising”, “includes”, and/or “including” when used in this specification, specify the presence of stated features, integers, steps, operations, elements, components, and/or groups thereof, but do not preclude the presence or addition of one or more other features, integers, steps, operations, elements, components, and/or groups thereof.

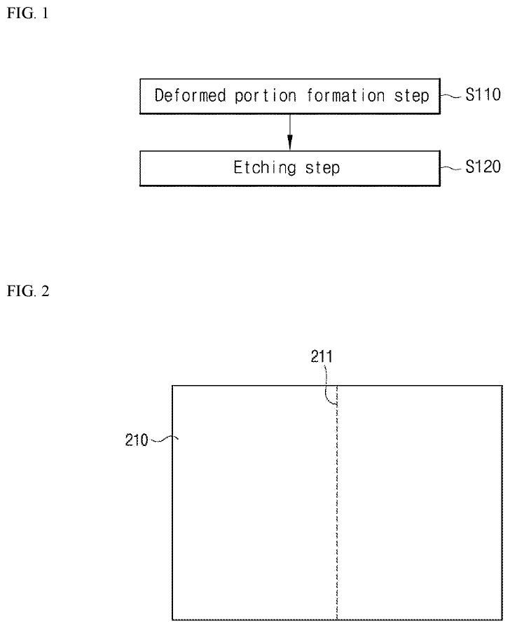

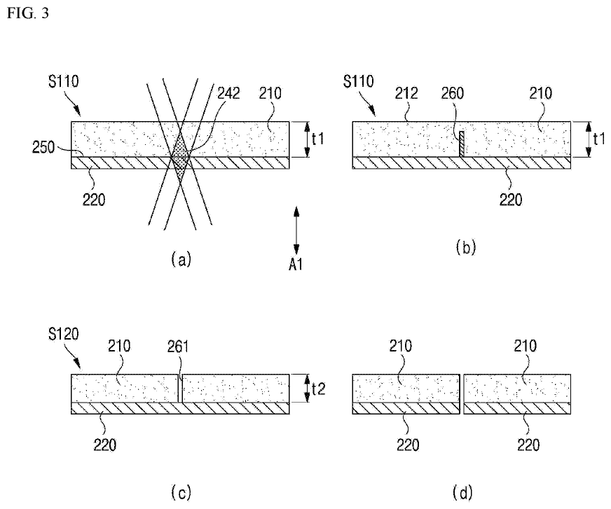

FIG. 1 is a flowchart of a glass panel processing method according to one embodiment of the present invention, FIG. 2 is a schematic plan view illustrating the glass panel processing method according to the embodiment, and FIG. 3 is a schematic sectional view illustrating the glass panel processing method according to the embodiment.

Referring first to FIG. 3, a glass panel processed by the glass panel processing method according to this embodiment includes a glass substrate 210 and a display layer 220.

The glass substrate 11 serves as a base substrate during a series of processes in which a mother glass panel (see FIG. 3(a)) is manufactured into multiple unit glass panels (see FIG. 3(d)) to produce a glass panel for display devices.

The display layer 12 is laminated on one surface of the glass substrate 11 to display an image. For example, for an OLED glass panel, the display layer 12 may be composed of a circuit layer, an organic light emitting layer, an encapsulation layer, and an interconnect. Components of the display layer 12 may be varied depending on the type of display material used (for example, OLED, LCD, and the like).

Although not shown in the drawings, the glass panel may further include a protective layer covering the display layer 220. The protective layer may protect the display layer 220 from an etchant. As will be described below, during a process in which a mother glass panel is cut into multiple unit glass panels, the glass panel may be immersed in an etchant. Here, the protective layer 13 may prevent damage to the display layer 220 due to the etchant. In the present invention, the protective layer may be provided in the form of a film to be attached to one surface of the display layer 220 during the process.

Referring to FIG. 1 to FIG. 3, the glass panel processing method may include a deformed portion formation step S110 and an etching step $120.

In the deformed portion formation step S110, in order to process the glass substrate 210, a deformed portion is formed inside the glass substrate 210 through irradiation with a Bessel beam 242 along a planned processing line 211 on the glass substrate 210.

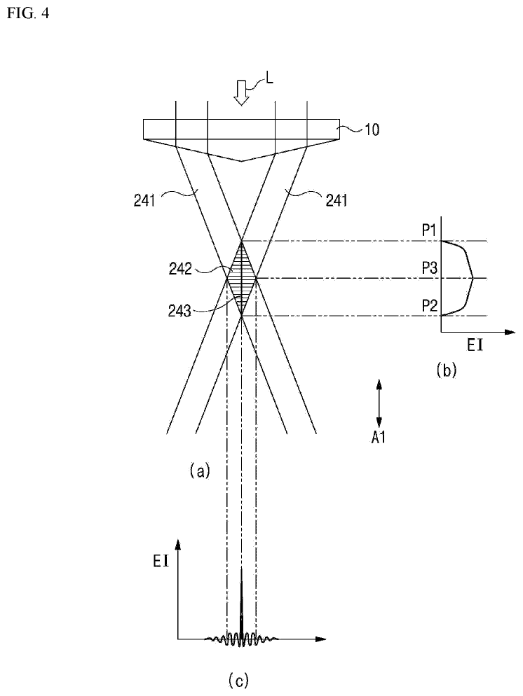

FIG. 4 is a schematic view illustrating a Bessel beam used in the glass panel processing method according to one embodiment of the present invention.

Referring to FIG. 4, laser beams L incident on an axicon 10 may exit the axicon 10 as processing laser beams 241.

The processing laser beams 241 cross each other in a delivery direction thereof. Accordingly, in the front of the axicon 10 in a direction in which the processing laser beams 241 exit the axicon 10, the processing laser beams 241 overlap each other to form a Bessel beam 242.

Referring to FIG. 4(b), with respect to the delivery direction of the processing laser beams 241, energy intensity EI of the Bessel beam 242 greatly increases at a first point P1, at which the Bessel beam 242 starts, and greatly decreases at a second point P2, at which the Bessel beam 242 ends. At a third point P3, which is a central point of the Bessel beam 242, energy intensity EI of the Bessel beam 242 is at a maximum thereof.

In addition, referring to FIG. 4(c), with respect to a direction perpendicular to the delivery direction of the processing laser beams 241, energy intensity EI of the Bessel beam 242 is at a maximum thereof at a center of the Bessel beam 242.

Accordingly, the Bessel beam 242 may produce a high-intensity focus 243 having a linear shape in the delivery direction of the processing laser beams 241.

Referring again to FIG. 1 to FIG. 4, in the deformed portion formation step S110, the Bessel beam 242 may be delivered in a thickness direction A1 of the glass substrate 210. In addition, the Bessel beam 242 may be delivered such that the focus 243 thereof is positioned on a planned processing line 211.

The planned processing line 211 may be a line along which a mother glass panel is cut into multiple unit glass panels. In addition, the planned processing line 211 may be a guide line for forming a speaker hole, a camera hole, or the like in the glass panel. The planned processing line 211 may be a virtual line.

Since the focus 243 of the Bessel beam 242 has high energy intensity, when the Bessel beam 242 is positioned in the glass substrate 210, a melt layer may be formed in a region of the glass substrate 210, in which the focus 243 of the Bessel beam 242 is formed. However, in regions other than the region with the focus 243 formed therein, there may be no alteration of a substrate material. That is, when the Bessel beam 242 is positioned in the glass substrate 210, thermal energy may be effectively applied only to a region with the focus 243 of the Bessel beam 242 formed therein. In this way, the deformed portion 260 may be formed inside the glass substrate 210) in the thickness direction A1 of the glass substrate 210.

Specifically, phase transition from an α-phase to a α-phase may occur in the region of the glass substrate 210 with the focus 243 of the Bessel beam 242 formed therein. That is, the deformed portion 260 may be in the ß-phase.

In the deformed portion 260, permanent physicochemical structural deformation occurs by a nonlinear photoionization mechanism induced by the Bessel beam 242. The region of the glass substrate 210 with the focus 243 of the Bessel beam 242 formed therein becomes rich in Si and undergoes densification and thus changes in index of refraction.

The deformed portion 260 may be etched by an alkaline or acidic chemical solution dozens to hundreds of times faster than the other regions of the glass substrate 210. Here, the etching rate may be regulated by various parameters, such as laser intensity, pulse duration, repetition rate, wavelength, focal length, scan rate, and concentration of the chemical solution.

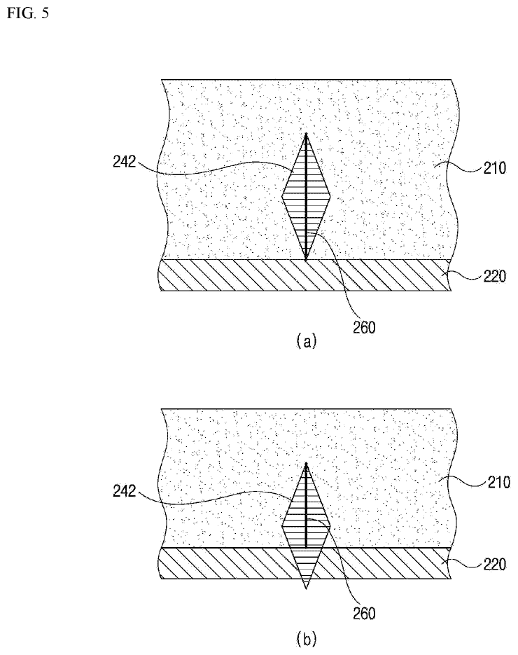

FIG. 5 is a schematic sectional view illustrating an example of formation of the deformed portion depending on conditions of irradiation with the Bessel beam in the glass panel processing method according to one embodiment of the present invention.

Referring to FIG. 4 and FIG. 5, the deformed portion 260 may be formed to a length corresponding to the length of the focus 243 of the Bessel beam 242, which is formed in the glass substrate 210.

That is, when the entirety of the Bessel beam 242 is positioned inside the glass substrate 210, as shown in (a) of FIG. 5, the deformed portion 260) may be formed over the entirety of a region with the focus 243 of the Bessel beam 242 formed therein.

If the length of the deformed portion 260 is desired to be longer than that shown in FIG. 5(a), the length of the deformed portion 260 may be increased by moving the Bessel beam 242 in the thickness direction of the glass substrate 210 or by increasing the size of the Bessel beam 242 to increase the length of the focus 243 formed in the glass substrate 210.

On the other hand, if the length of the deformed portion 260 is desired to be shorter than that shown in FIG. 5(a), the length of the deformed portion 260 may be decreased by allowing only a portion of the Bessel beam 242 to be positioned in the glass substrate 210 to reduce the length of the focus 243 formed in the glass substrate 210.

Since the display layer 220 includes a metal material, the display layer 220 may have a greater reflectance than the glass substrate 210. Accordingly, when a portion of the Bessel beam 242 falls on the display layer 220, the display layer 220 may reflect the Bessel beam 242 incident thereon. Here, the Bessel beam 242 falling on the display layer 220 may be reflected back to the glass substrate 210 with respect to an interface 250 (see FIG. 3) between the glass substrate 210 and the display layer 220.

As a result, the reflected Bessel beam may also be focused inside the glass substrate 210. Accordingly, both the Bessel beam initially delivered to the glass substrate 210 and the Bessel beam reflected back to the glass substrate 210 from the display layer 220 may form a focus inside the glass substrate 210.

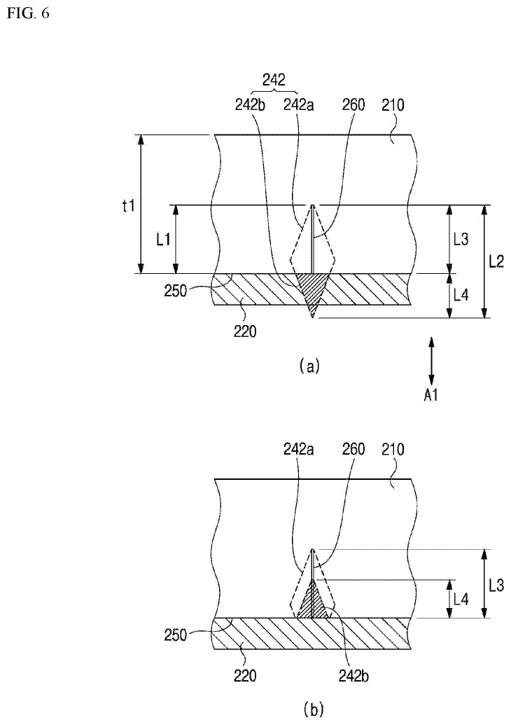

This will be described in detail with reference to FIG. 6.

FIG. 6 is a schematic view illustrating an example of irradiation with the Bessel beam in the glass panel processing method according to one embodiment of the present invention.

Referring to FIG. 6, in order to form the deformed portion 260 having a desired length L1 inside the glass substrate 210, the Bessel beam 242 needs to be delivered to the glass substrate 210 such that a focus having a length corresponding to the desired length L1 of the deformed portion 260 is formed in the glass substrate 210.

However, if the desired length L1 of the deformed portion 260 is smaller than the overall length L2 of the Bessel beam 242, a portion 242a of the Bessel beam may be delivered to the glass substrate 210 such that a focus having a length corresponding to the desired length L1 of the deformed portion 260 is formed in the glass substrate 210, as shown in FIG. 6(a).

Here, the other portion 242b of the Bessel beam may fall on the display layer 220 and then may be reflected back to the glass substrate 210 from the display layer 220 (see FIG. 6(b)). As a result, a focus of the reflected Bessel beam 242b may also be formed in the glass substrate 210.

Assuming that the length of the portion 242a of the Bessel beam delivered to the glass substrate 210 is L3 and the length of the portion 242b of the Bessel beam falling on the display layer 220 is L4, if L3 is greater than L4, the portion 242b of the Bessel beam reflected back to the glass substrate 210 is shorter than the portion 242a of the Bessel beam initially delivered to the glass substrate 210.

Accordingly, even when respective focuses of the two portions of the Bessel beam 242a, 242b overlap each other, the focus of the reflected portion 242b of the Bessel beam is shorter than the focus of the portion 242a of the Bessel beam 242a initially delivered to the glass substrate 210. As a result, the deformed portion 260 finally formed inside the glass substrate 210 has a length L1 corresponding to the length of the focus of the portion 242a of the Bessel beam initially delivered to the glass substrate 210.

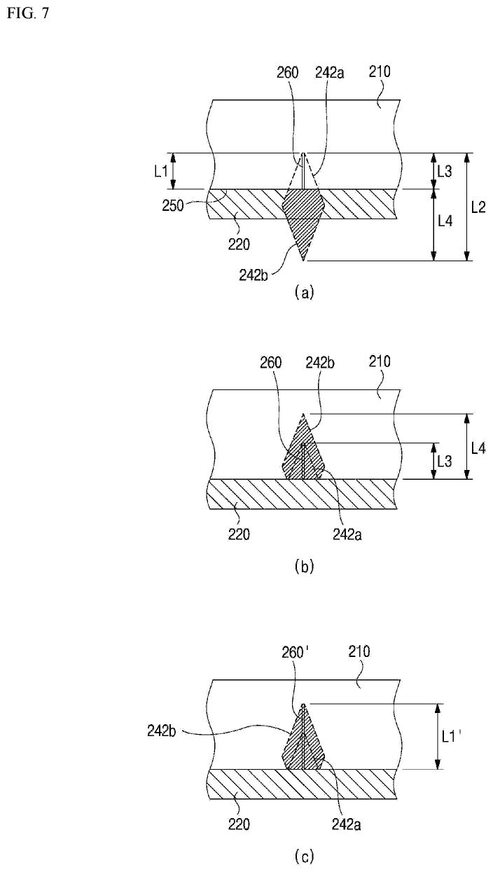

FIG. 7 is a schematic view illustrating a comparative example of irradiation with the Bessel beam for comparison with the example of FIG. 6.

Referring to FIG. 7, if L3 is smaller than L4, the portion 242b of the Bessel beam reflected back to the glass substrate 210 from the display layer 220 is longer than the portion 242a of the Bessel beam initially delivered to the glass substrate 210.

Accordingly, when the respective focuses of the two portions of the Bessel beam 242a, 242b overlap each other, the focus of the reflected portion 242b of the Bessel beam is longer than the focus of the portion of the Bessel beam 242a initially delivered to the glass substrate 210. As a result, a deformed portion 260′ finally formed inside the glass substrate 210 has a length L1′ greater than the desired length L1.

In order to prevent this problem, in the deformed portion formation step S110, the glass substrate 210 may be irradiated with the Bessel beam 242 with half or more of the overall length L2 of the Bessel beam 242 positioned at the glass substrate 210 side with respect to the interface 250 between the glass substrate 210 and the display layer 220.

In other words, in the deformed portion formation step S110, irradiation with the Bessel beam 242 may be performed such that ½ or more of a maximum length L2 of the Bessel beam 242 in the thickness direction A1 of the glass substrate 210 is equal to the desired length of the deformed portion 260. In this way, even when a portion of the Bessel beam is reflected back to the glass substrate 210 from the display layer 220, a deformed portion having a desired length can be formed inside the glass substrate 210.

Referring again to FIG. 1 to FIG. 3, in the etching step S120, the deformed portion 260 is removed by etching the glass substrate 210 in a direction from the other surface 212 of the glass substrate 210 to the one surface of the glass substrate 210, that is, in the direction of the interface between the glass substrate 210 and the display layer 220.

In the etching step S120, etching of the glass substrate 210 may be performed by various methods, such as immersing the glass substrate 210 in an etchant, spraying an etchant onto the glass substrate 210, and the like. In this embodiment, it is assumed that etching of the glass substrate 210 is performed by immersing the glass substrate 210 in an etchant.

In the deformed portion formation step S110 described above, irradiation with the Bessel beam 242 may be performed such that the deformed portion 260 having a length smaller than the thickness of the glass substrate 210 is formed inside the glass substrate 210.

As shown in FIG. 3(b) and FIG. 3(c), as the other surface 212 of the glass substrate 210 is etched and slimmed, the thickness of the glass substrate 210 is reduced. Then, when the deformed portion 260 is exposed over the other surface 212 of the glass substrate 210, the deformed portion 260 starts to be etched. Then, etching is continued in the direction of the one surface of the glass substrate 210 until the deformed portion 260 is removed and the glass substrate 210 breaks 261.

Since the deformed portion 260 is etched faster than the other surface 212 of the glass substrate 210, as described above, etching of the other surface 212 of the glass substrate 210 proceeds slowly while the deformed portion 260 is etched. However, eventually, the glass substrate 210 is slimmed to a final thickness t2, which is smaller than an initial thickness t1.

The length of the deformed portion 260 may be set according to a desired final thickness t2 of the glass substrate 210. That is, in order to increase the final thickness t2 of the glass substrate 210, it is desirable that the length of the deformed portion 260 be set to a large value. In addition, in order to decrease the final thickness t2 of the glass substrate 210, it is desirable that the length of the deformed portion 260 be set to a small value.

That is, in order to ensure that the glass substrate 210 has an exact desired final thickness t2, it is critical to form the deformed portion 260 to an exact desired length. According to the present invention, it is possible to improve accuracy in forming the deformed portion 260 to the desired length.

Etching time may be appropriately set according to the type of etchant, the final thickness t2 of the glass substrate 210, the length of the deformed portion 260, and the like.

After etching of the deformed portion 260 is completed, the display layer 220 is cut, thereby obtaining unit glass panels (see FIG. 3(d)) from a mother glass panel.

Although some embodiments have been described herein, it should be understood that these embodiments are provided for illustration only and are not to be construed in any way as limiting the present invention, and that various modifications, changes, alterations, and equivalent embodiments can be made by those skilled in the art without departing from the spirit and scope of the invention. For example, components described as implemented separately may also be implemented in combined form, and vice versa.

The scope of the present invention is indicated by the following claims and all changes or modifications derived from the meaning and scope of the claims and equivalents thereto should be construed as being within the scope of the present invention.

1. A method of processing a glass panel comprising a glass substrate and a display layer disposed on one surface of the glass substrate to display an image, the method comprising:
a deformed portion formation step in which, in order to process the glass substrate, a deformed portion is formed inside the glass substrate through irradiation with a Bessel beam along a planned processing line on the glass substrate; and
an etching step in which the deformed portion is removed by etching the glass substrate in a direction from the other surface of the glass substrate to the one surface of the glass substrate,
wherein, in the deformed portion formation step, irradiation with the Bessel beam is performed with half or more of the overall length of the Bessel beam positioned at the glass substrate side with respect to an interface between the glass substrate and the display layer.

2. The method according to claim 1, wherein the display layer has a greater reflectance than the glass substrate.

3. The method according to claim 1, wherein, in the deformed portion generating step, irradiation with the Bessel beam is performed such that the deformed portion is formed to a length smaller than a thickness of the glass substrate.
